(19) United States
(12) Patent Application Publication
(10) Pub. No.: US 2002/0143518 A1
(43) Pub. Date: Oct. 3, 2002

(54) Dynamically adaptable digital architecture system

(76) Inventor: Carl K. Abrahamson, Midwest City, OK (US)

Correspondence Address: MARSTELLER & ASSOCIATES, P O BOX 803302, DALLAS, TX, 75380-3302, US

(21) Appl. No.: 09/820,049

(22) Filed: Mar. 28, 2001

(51) Int. Cl. G06F 17/50

(52) U.S. Cl. 703/20

(57) ABSTRACT

An electronic system (L) has a configurable electronic circuit (38) for replicating an output signal from a respective known electronic system replaceable sub-component module (32) of a known electronic master system (L). The output signal (68) from the electronic system sub-component (32) is generated as the result of the function of the electronic system sub-component (32). An input/output interface (30) electronically mates the configurable electronic circuit (38) to the electronic master system (L). A configuration controller element (40) is electronically connectable with the configurable electronic circuit (38), and configures the configurable electronic circuit (38) to replicate a selected function and operational characteristics of the known electronic system sub-component (32). The configurable electronic circuit (38) further has an output (70) adaptable or suitable as an input to the electronic master system (L) to replicate and replace functions of the known electronic system sub-component (32) acting in the electronic master system (L).

### BACKGROUND OF THE INVENTION

1. Technical Field

The invention relates to the field of electronic circuit modules, and more particularly to circuit modules that are intended as replacement circuit modules for known electronic systems.

2. Background Art

Military systems have had to battle problems with obsolete components and parts availability. These problems threaten the war fighting capabilities of many military systems, and continue to escalate system support costs. Traditional methods of responding to these issues involve everything from lifetime buys of components and parts to total system redesign.

Lifetime buys are risky. In order to be effective, the service life of the system must be reliably known. If the service life is extended, or component failure rates escalate, the component supply will be exhausted before the system is retired, thereby reducing the expected life cycle of the item. For example, if a circuit board function is ever changed, the board will need to be redesigned making all the “lifetime buy parts” unusable.

Board, box, or system level redesign is often one proposed solution when obsolescence becomes a major support problem. This option involves a long and complex system requirements analysis process, developing new design specifications, and integrating and testing the new designs. Unfortunately, this process can be so long and so complex that often the new system design begins to experience obsolescence problems even before it is put into production. Additionally, since the design has changed, support equipment and test procedures must be modified or replaced as well.

Also, a new design can introduce new problems or “bugs” in the system. These new “bugs” require even more time to identify, isolate, and eliminate. If that were not enough—the new design must be retrofitted to every system in existence to avoid supporting two unique systems. This alternative is often expensive.

The known solutions only offer temporary fixes to obsolescence, and do not offer a lasting, low-cost resolution to the problems.

Currently fielded designs (“legacy” systems) suffer from obsolescence primarily because the circuit boards are heavily populated with electrical or electronic components that have very specific functions. These components are so highly specialized that often there was only one supplier of the components when the board was designed. Technology advances rapidly made these components obsolete. Suppliers have dropped needed components from their product line making suitable replacements unavailable.

In contrast, the present invention uses “generic” components to emulate known components in certain legacy systems. An unprogrammed circuit card according to the present invention is, in essence, a “blank slate.” Firmware defines the functionality. Since there are no application-specific components in the design, users easily find functional replacements that will be available indefinitely. Updating a specific design of the present invention to accommodate new components is a comparatively quick and inexpensive task because of the innovative approach the present invention uses.

While the above-cited examples introduce and disclose a number of noteworthy advances and technological improvements within the art, none completely fulfills the specific objectives achieved by this invention.

### DISCLOSURE OF INVENTION

In accordance with the present invention, an electronic system has configurable electronic circuitry for replicating an output signal from a respective known electronic system replaceable sub-component of a known electronic master system having at least one such sub-component. The output signal from the electronic system sub-component is generated as the result of the function of the electronic system sub-component. An input/output interface electronically mates the configurable electronic circuit to the electronic master system. A configuration controller element is electronically connectable with the configurable electronic circuit, and configures the configurable electronic circuit to replicate a selected function and operational characteristics of the known electronic system sub-component. The configurable electronic circuit further has an output adaptable or suitable as an input to the electronic master system to replicate and replace functions of the known electronic system sub-component acting in the electronic master system.

The present invention of Dynamically-Adaptable Digital Architecture (DADA) is a new solution to the problems being faced for the long-term sustainment of aging digital systems. The goal of the present invention is to give users new options to support aging digital systems at low-cost for indefinite lifespans.

One of the most prolific features of the present innovative architecture is the concept of dynamic adaptability. DADA designs are Form, Fit, and Function replacements for existing Circuit Card Assemblies (CCAs). A DADA design can be used in a system without any system modifications. The DADA design can be installed into multiple CCA locations. The function of the card adapts to meet the system requirements of the CCA it is replacing by simply setting a configuration switch to the desired function. The present DADA approach could replace an entire legacy system of unique CCAs with multiple instances of the same DADA design.

The DADA re-implementation methodology is grounded on the premise that the boards being replaced meet operational performance requirements, but are not supportable for other reasons. By re-implementing existing designs, one can achieve identical functionality much faster than through a total redesign effort.

If the existing design does have functional problems or the existing function must be modified, the present invention also supports total redesign efforts.

Embedded firmware is a key to the approach of the present invention. Since a specific DADA design has no hard-wired system functionality, the actual application is created using firmware to accomplish the needed system functions. This firmware is created using an industry-standard programming language, such as VHDL. The development language allows firmware to be developed that is not locked to a specific device vendor or set of development tools.

The present invention also focuses on modeling the legacy designs on a component-by-component basis. First, one develops behavioral models for each discrete part used in the legacy design. Then, the part models are tested head-to-head with the actual discrete part. Once a proven model is identified, the electronic model is “connected” in firmware in the same way as the legacy card is connected or wired to produce the legacy functionality. Once proven, the part models can be “archived” as discrete “parts” for any subsequent design that needs the specific legacy component.

To modify the functional performance of the DADA circuit, one can implement these changes rapidly. Since the functionality of the application is completely contained in firmware, one can rapidly implement and load modifications onto the card without a single hardware change. This rapid functional modification is extremely useful in applications where the war fighter needs to modify performance to counter changing enemy threats.

One can use the same hardware to load a DADA application that is not internally stored on the CCA. This makes it easy to test the hardware (at the repair shop, for instance), and to load code to be tested without having to remove the card from the system.

Many systems currently in use face serious obsolescence issues as a result of legacy microprocessors that are no longer procurable. Traditionally, redesign of a microprocessor-based circuit requires both hardware and software changes. Redesigning the embedded software is often a very complex task. Since one seldom has design data for the legacy software, the user must reverse engineer all the requirements from the operational system. This process is expensive, time-consuming, and introduces many new anomalies to system performance.

These and other objects, advantages and features of this invention will be apparent from the following description taken with reference to the accompanying drawings, wherein is shown the preferred embodiments of the invention.

### BRIEF DESCRIPTION OF DRAWINGS

A more particular description of the invention briefly summarized above is available from the exemplary embodiments illustrated in the drawing and discussed in further detail below. Through this reference, it can be seen how the above cited features, as well as others that will become apparent, are obtained and can be understood in detail. The drawings nevertheless illustrate only typical, preferred embodiments of the invention and are not to be considered limiting of its scope as the invention may admit to other equally effective embodiments.

FIG. 1 is a schematic diagram of the present invention.

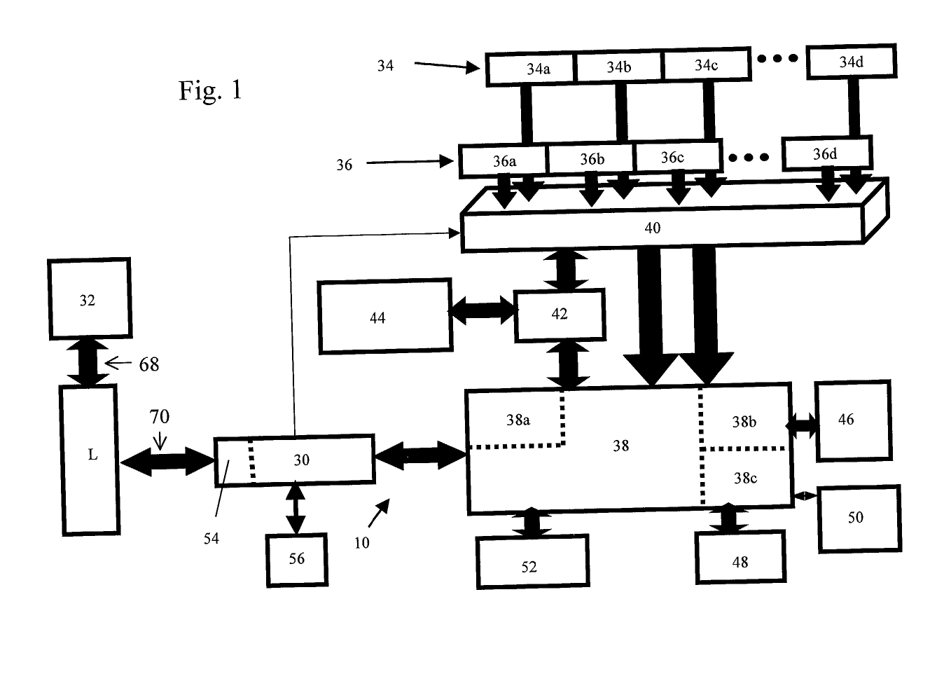

FIG. 2 is a depiction of a removable circuit card embodying the present invention.

### MODE(S) FOR CARRYING OUT THE INVENTION

So that the manner in which the above recited features, advantages and objects of the present invention are attained can be understood in detail, more particular description of the invention, briefly summarized above, may be had by reference to the embodiment thereof that is illustrated in the appended drawings. In all the drawings, identical numbers represent the same elements.

An electronic system (L) has a configurable electronic circuit (38) for replicating an output signal from a respective known electronic system replaceable sub-component module (32) of a known electronic master system (L) having at least one such sub-component. The output signal (68) from the electronic system sub-component (32) is generated as the result of the function of the electronic system sub-component (32). An input/output interface (30) electronically mates the configurable electronic circuit (38) to the electronic master system (L). A configuration controller element (40) is electronically connectable with the configurable electronic circuit (38), and configures the configurable electronic circuit (38) to replicate a selected function and operational characteristics of the known electronic system sub-component (32). The configurable electronic circuit (38) further has an output (70) adaptable or suitable as an input to the electronic master system (L) to replicate and replace functions of the known electronic system sub-component (32) acting in the electronic master system (L).

The Input Output (I/O) interface module (30) of the present invention (10) is a known type of circuit board that traces and connects to a legacy or electronic master system (L). The I/O interface (30) may also include specialized interface devices (line driver/receivers, etc), if required. The I/O interface (30) may optionally be customized or designed to a specific application to match the known I/O specifications or operational characteristics of the legacy circuit module (32) that the DADA module (10) replaces.

The operational program or OP Memory (34 and 34a through 34d) is a block of known type of computer memory that reduces to a memory device(s) to contain executable software that is to be executed for a selected function. The software is stored in the memory device(s) (34a to 34d) utilizing a known paging scheme, so that no code modification should be necessary.

The card function memory (36 and 36a through 36d) is also a paged scheme. That is, each page of memory contains the necessary configuration data used to program the reconfigurable hardware module (38) to the desired legacy function to produce or cause to be generated one or more output signals that replicate respective output signals created by desired functioning of the legacy circuit sub-component (32).

The configuration controller (40) will determine the location in the system (L) that the DADA board or system (10) is to replace by inspecting features of the I/O interface (30), such as automatic slot detection, or by reading a binary configuration number set using a multiplexed switch (manual slot identification). Once the needed function is identified, the proper configuration data is provided to the reconfigurable hardware (38) for programming. If the selected function requires microprocessor support, the configuration controller (40) selects the appropriate OP from memory or information storage element (34a through 34d), and enables it to be accessed and executed.

When an external interface (42) is connected, a computer or processor (44), possibly external to the DADA board (10) will be able to load an In-System Programmer (ISP) circuit or application (46) onto the reconfigurable hardware (38). This programmer (46) will give the ability to program or load instructions and verify both the card function memory or information storage element (36) and the OP memory (34). Either the entire memory device can be updated with new code, or just a specific configuration position can be modified.

Once the reconfigurable hardware (38) has been programmed from the external computer (44), the ISP circuit (46) is activated.

Once the ISP (46) has been activated, any block of memory, such as the OP memory (34a through 34d) or the card function memory (36a through 36d) can be erased, programmed or verified by the user using a software tool such as the Litton TASC-designed Windows In-System Programmer (WISPer) Tool, by way of example.

The reconfigurable hardware circuit (38), in addition to the ISP mode mentioned previously, has many different operating modes. Primarily, the reconfigurable hardware (38) will accept the functional configuration data, and configure itself to perform that function. For example, there may be an application of the legacy circuit module (32) that is purely digital combinatorial logic, that is, it does not have a microprocessor (48). Since there is no microprocessor (48), no operational program (OP) will exist in the corresponding OP memory (34).

Typically, the reconfigurable hardware module or chip (38) will be a known field programmable gate array (FPGA).

When a specific design is being implemented that has a microprocessor (48), there are more issues to address. There are two different ways the DADA hardware (10) can accommodate a legacy processor (32).

The first method is to construct a firmware-based model of the legacy microprocessor. This model example is designed to support the legacy instruction set and execute at the legacy clock rate for the electrical circuit. This microprocessor model is fully contained within the reconfigurable hardware (38). An external Random Access Memory (RAM) (50) can be used if the internal resources of the reconfigurable hardware (38) are not sufficient.

A glue logic block (52) is a firmware model of the rest of the card, or basically the glue logic block (52) is the combinatorial logic needed to interface the microprocessor (48) to the rest of the system. This glue logic block (52) is modeled from the same data that connected the legacy microprocessor (32) to the rest of the system (L).

The second option to add microprocessor support is to incorporate a new microprocessor chip (48) into the DADA board or component (10). This new processor (48) will be running an emulator, to enable it to read and execute legacy instructions on the new microprocessor.

The glue logic (52) and RAM (50) in this optional design serves the same purpose as in the previous option.

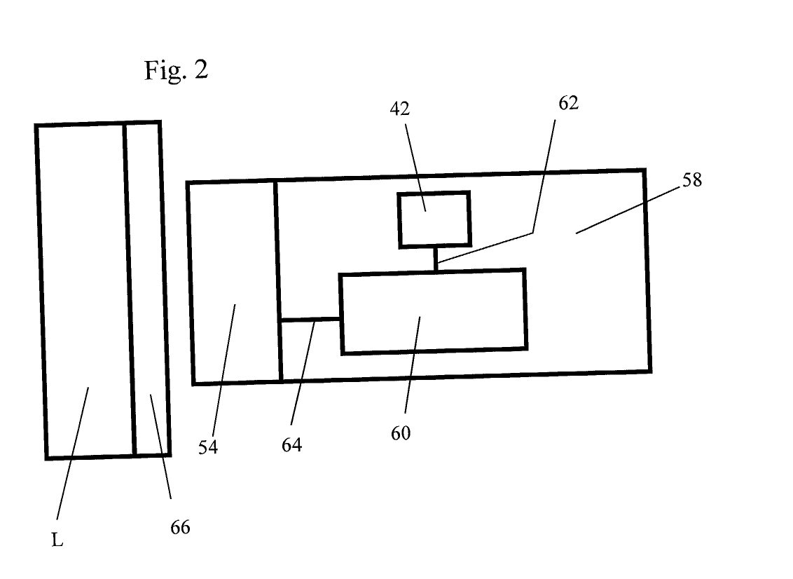

FIG. 2 depicts one alternative embodiment of the present invention with a known type of a removable circuit card or board assembly (58) having the connector (54), processor circuit (60), and external interface component (42) affixed thereto or forming an integral part thereof. The processor circuit (60) may include or combine the functions of the reconfigurable hardware (38) and the I/O interface (30). The external interface (42) is electrically connected to the processor (60) by connector or connection (62). Similarly, the processor (60) is electrically connected to the connector (54) through connector or connection (64).

The connector (54) with board (58) mates electrically with a connector or connection system (66) that is electrically connected to the legacy system (L). Preferably, the connection between the legacy system (L) and board (58) is adapted to be reconnectable and the board (58) removable from the master system (L), but the connection may be fixed or permanent as desired.

Board Test Mode

The reconfigurable properties of the present DADA design (10) can be exploited to allow testing of the board or module (10) utilizing an object-oriented approach. The components can be tested one-by-one with each time reloading the new tests from an external computer (44).

The reconfigurable hardware (38) can be verified. For these reconfigurable hardware tests, a first portion (38a) of the reconfigurable hardware (38) will be used to test a different portion (38b) of the device.

Once the first test pass is complete, the board or module (10) can be reconfigured to test a different section of the board (38c).

The process can be repeated until the entire reconfigurable hardware portion or chip (38) is checked.

Next, the board (10) may be reconfigured to test the configuration controller (40). Test vectors can optionally be generated. All the test results should be monitored with instrumentation to ensure that the configuration controller is fully functional.

The memory devices (34 or 36) can be checked next. Both the OP (34) and the card function memories (36) can be checked in the same manner, but preferably should not be tested simultaneous.

First, the memory will be commanded to clear. The cleared memory will be verified. Then the memory will be programmed with a specific pattern to ensure that all data and address lines are functional. This pattern should be verified. Third, the memory will be programmed with the inverse pattern used in the prior step. (This is to ensure that all locations can be set to 1 or 0.) This should also be verified.

Then, the appropriate data can be programmed and verified on the chip (38).

This sequence of tests is designed to ensure that the memory is fully capable of all operations, and contains the appropriate data on completion.

Finally, the circuit card's I/0 (30) and connector (54) should be tested with the addition of signals injected into an interface test adapter (56) and measured in the reconfigurable hardware (38).

The microprocessor (48) and external RAM (50) can be checked using a similar methodology.

At this point in the optional testing procedure, all components and circuit traces should have been checked to assure functionality.

One can rapidly load modifications to the DADA functionality onto the design using widely available equipment. For example, to update the present DADA configurations requires the following equipment:

A Windows 95/98/NT-based or similar type of computer

A simple Active Cable Assembly

A PC software tool to load the code

As an alternative to traditional approaches, a microprocessor capability for the present invention is possible. This technology provides a “virtual legacy processor” that will run the legacy software without modification. From the software's perspective, it will appear to be running on the legacy microprocessor.

The present invention opens up possibilities to develop object-oriented test methodologies. Since the DADA designs support multiple legacy CCA functional designs in a single hardware configuration, it is likely possible to exhaustively test the underlying hardware of the CCA, rather than the plethora of specific functions of the legacy designs that DADA replaces.

The present invention can also be a technique for new systems design. Using this technology from the inception of a new design would help posture the new system for long-term supportability.

The foregoing disclosure and description of the invention are illustrative and explanatory thereof, and various changes in the size, shape and materials, as well as in the details of the illustrated construction may be made without departing from the spirit of the invention.

I claim:

1. An electronic system comprising:
configurable electronic circuitry means for replicating an output signal from a respective known electronic system sub-component of a known electronic master system, the output signal corresponding to a function of the electronic system sub-component;
an input/output interface for electronically mating the configurable electronic circuit to the electronic master system; and
a configuration controller element electronically connectable with the configurable electronic circuit, the configuration controller configures the configurable electronic circuit to replicate a selected function and operational characteristics of the known electronic system sub-component;
wherein the configurable electronic circuit has an output adaptable as an input to the electronic master system to replicate and replace functions of the known electronic system sub-component acting in the electronic master system.

2. The invention of claim 1 wherein:
the configurable electronic circuit and the input/output interface are mounted with a circuit card assembly.

3. The invention of claim 1 wherein:
the configuration controller determines location of the configurable electronic circuit within the electronic master system.

4. The invention of claim 1 further including a processor means external to the configurable electronic circuit to load instructions onto the configurable electronic circuit.

5. The invention of claim 1 wherein the configurable electronic circuit further includes memory means for storing electronic information.

6. The invention of claim 1 wherein the configurable electronic circuit includes digital logic circuitry.

7. The invention of claim 1 further including a microprocessor means for executing an emulator program of instructions from the known electronic system sub-component.

8. A method of configuring an electronic circuit module to replicate output signals from a known electronic circuit comprising:
determining operational functions and respective output signals of a known electronic system sub-component of an existing electronic master system;
developing a program on an external processor to replicate desired functions of the known electronic system sub-component; and
loading the program onto a configurable electronic circuit that can be electronically connected to the electronic master system;
whereby the configurable electronic circuit has an output adaptable as an input to the electronic master system to replicate and replace functions of the known electronic system sub-component acting in the electronic master system.

9. The invention of claim 8 wherein the configurable electronic circuit is included with a circuit board that can be electronically connected to the electronic master system.

10. The invention of claim 9 wherein the circuit board is removable from the electronic master system.
